(19) United States
(12) Patent Application Publication
(10) Pub. No.: US 2023/0418904 A1
(43) Pub. Date: Dec. 28, 2023

(54) METHODS, SYSTEMS, ARTICLES OF MANUFACTURE AND APPARATUS TO IMPROVE ISOTONIC REGRESSION

(71) Applicant: Nielsen Consumer LLC, Chicago, IL (US)

(72) Inventors: Kai Jan Kopperschmidt, Frankfurt (DE); Ruslanas Stacevicius, Vilnius (LT)

(21) Appl. No.: 18/319,891

(22) Filed: May 18, 2023

Related U.S. Application Data
(60) Provisional application No. 63/354,983, filed on Jun. 23, 2022.
(60) Provisional application No. 63/354,574, filed on Jun. 22, 2022.

(51) Int. Cl. G06F 17/18

(52) U.S. Cl. CPC G06F 17/18

(57) ABSTRACT

Methods, apparatus, systems, and articles of manufacture are disclosed to improve isotonic regression, the methods, apparatus, systems, and articles of manufacture comprising: interface circuitry; machine readable instructions; and programmable circuitry to at least one of instantiate or execute the machine readable instructions to: analyze a set of data points to generate a subset of data points that violate a trend rule; average the subset of data points to establish a pooled data point value; and adjust the pooled data point value to satisfy an upper boundary and a lower boundary corresponding to respective subset data point interval bound information to generate a minimizer.

### RELATED APPLICATION

This patent claims the benefit of U.S. Provisional Patent Application No. 63/354,574, filed Jun. 22, 2022. This patent also claims the benefit of U.S. Provisional Patent Application No. 63/354,983, filed Jun. 23, 2022, both of which are hereby incorporated herein by reference their entireties. Priority to U.S. Patent Application No. 63/354,574 and U.S. Patent Application No. 63/354,983 are hereby claimed.

### FIELD OF THE DISCLOSURE

This disclosure relates generally to interval constraints and, more particularly, to methods, systems, articles of manufacture to improve isotonic regression.

### BACKGROUND

In recent years, methods to pool adjacent violators have been applied to solve isotonic regression problems. Isotonic regression algorithms have allowed for the automation of fitting data into a non-decreasing or a non-increasing sequence.

### BRIEF DESCRIPTION OF THE DRAWINGS

FIG. 1 is a schematic diagram of an example environment to improve isotonic regression structured in accordance with teachings of this disclosure.

FIG. 2 is a block diagram of example pool circuitry to improve isotonic regression.

FIGS. 3-4 are flowcharts representative of example machine readable instructions and/or example operations that may be executed by example processor circuitry to implement the pool circuitry of FIG. 1.

FIG. 5 is a graph of an example fifty data points prior to the example pool circuitry of FIG. 2 optimizing isotonic regression.

FIG. 6 is a graph of another example fifty data points prior to the example pool circuitry of FIG. 2 optimizing isotonic regression and a resultant solution after the pool circuitry optimizes.

FIG. 7 is a block diagram of an example processing platform including processor circuitry structured to execute the example machine readable instructions and/or the example operations of FIGS. 3-5 to implement the pool circuitry of FIG. 2.

FIG. 8 is a block diagram of an example implementation of the processor circuitry of FIG. 7.

FIG. 9 is a block diagram of another example implementation of the processor circuitry of FIG. 7.

FIG. 10 is a block diagram of an example software distribution platform (e.g., one or more servers) to distribute software (e.g., software corresponding to the example machine readable instructions of FIGS. 3-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Analyzing input data affords the ability to learn of trends and/or patterns of interest. However, some input data that is received and is to be used for further analysis includes one or more inconsistencies and/or errors. In some examples, inconsistent and/or erroneous data is strictly discarded. However, while inconsistent and/or erroneous data may lead to problematic conclusions in the event such data were relied upon, some aspects of the inconsistent and/or erroneous data still maintain some valuable information (e.g., trend information). Examples disclosed herein acknowledge and facilitate handling of such inconsistent and/or erroneous data in a manner that allows further analysis to continue while preserving as much value as possible from the erroneous and/or inconsistent data.

Examples disclosed herein may apply to any type of application and/or discipline. For instance, in the technical field of market research, in the event three different promotional packs of a particular lemonade brand are sold with different types of promotional variations (e.g., one pack includes one extra bottle for free, a second pack includes two extra bottles for free, and a third pack includes four extra bottles for free), then industry expectations include resulting growth, improved sales or other metrics indicative of a similar increase as the promotional packs include more substantial benefits to a consumer. However, if sales metrics are observed that show an increase in lemonade brand sales of 20%, 10% and 200% for the first, second and third promotional packs, respectively, then an inconsistency and/or error is believed to reside in the data. In other words, it is implausible that an extra promotional bottle of product would reduce a consumer's inclination to buy the brand. It would also be implausible that an extra promotional bottle of product would grow brand sales by 200% (e.g., because at most it has been observed to grow sales by no more than 150%).

Despite the apparent errors, completely throwing away collected data is a drastic decision that eliminates an opportunity to at least learn something from the data in the aggregate. Examples disclosed herein preserve collected data, despite some inconsistencies and/or errors, while applying corrective measures to improve accuracy in a manner that reduces computational effort of the underlying computing resources. For instance, examples disclosed herein adjust collected brand sales data to reflect 15%, 15% and 150%, which correspond to one, two and three extra promotional bottles, respectively. Examples disclosed herein provide solutions for problems including up to 150,000 input numbers using standard laptop computing resources. Additionally, examples disclosed herein perform such solutions much faster than traditional techniques (e.g., 47,000 input numbers are solved in 6.8 milliseconds with examples disclosed herein as compared to requiring 22 seconds using traditional techniques for the same quantity of input numbers). Examples disclosed herein correctly identify input data that does not allow for any solution, thereby saving computing resources by preventing pointless execution of the same when a solution is impossible. Further, examples disclosed herein generalize pooling of adjacent violators by finding optimal solutions with non-decreasing or non-increasing numbers. In some examples, violators are data points that violate constraints or violate a non-increasing or non-decreasing rule. Adjacent violators are data points near and or close to an acceptable data point that violate constraints or violate a non-increasing or non-decreasing rule, for example.

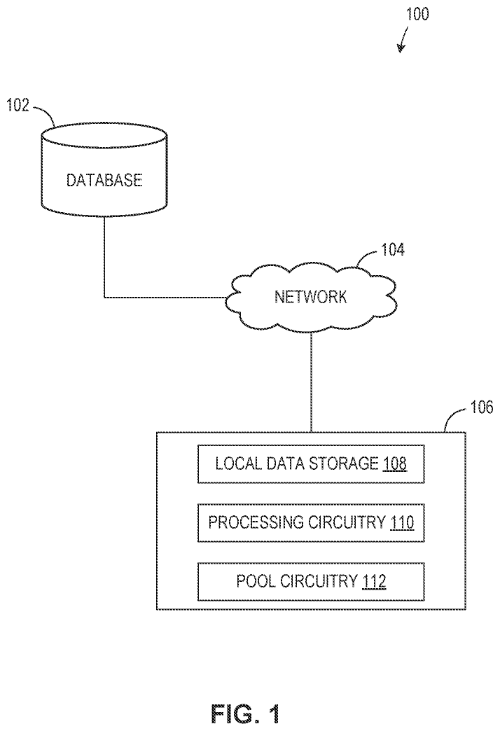

Constraint violators, as used herein, are data points that violate interval bounds and/or an upper boundary or a lower boundary. The interval bounds (e.g., an upper interval bound and a lower interval bound) are retrieved limits at each interval, for example, a data source will include metadata that identifies the interval bounds. For example, in a scenario where data is obtained corresponding to the number of soft drinks sold per a day at a convenience store, then the lower interval bound is zero and the upper interval bound is limited to the total amount of soft drinks available at the convenience store for a particular day. The upper boundary is obtained by adjusting (e.g., tightening) the upper interval bounds to create a non-increasing or non-decreasing limitation. The lower boundary is obtained by adjusting (e.g., tightening) the lower interval bounds to create a non-increasing or non-decreasing limitation. The lower boundary and upper boundary are discussed in greater detail in FIGS. 1, 5 and 6 below. Acceptable data points are those that fall within constraints and/or non-increasing or a non-decreasing rule. The solutions described herein are not limited to finding improved solutions with non-decreasing numbers. The solutions described herein may be applied to pooling adjacent violators by finding improved solutions with non-increasing numbers.

FIG. 1 is a schematic diagram of an example environment to improve isotonic regression structured in accordance with teachings of this disclosure. The environment to improve isotonic regression 100 (e.g., the “environment”) includes an example database 102, an example network 104, an example processor platform(s) 106, a local data storage 108, an example processing circuitry 110, and example pool circuitry 112. In some examples, the environment to improve isotonic regression 100 is referred to as an isotonic regression framework 100 containing particular computational structure arranged to operate in a manner that, in part, avoid wasteful resource utilization typically exhibited by traditional regression techniques.

As described above, the example environment to improve isotonic regression 100 addresses problems related to wasteful computational processing associated with solving isotonic regression problems. Isotonic regression, as defined herein, represents a technique of fitting a free-form line to a sequence of data points (e.g., observations, offers, etc.) such that the fitted line is non-decreasing (or non-increasing, depending on the particular application or use-case scenario) throughout the data points (e.g., observations, offers, etc.). Further, the fitted line remains as close to the data points (e.g., observations, offers, etc.) as possible. Isotonic regression is attractive for determining relations in data, such as, non-decreasing and non-increasing relations. Isotonic regression should not be confused with interpolation as isotonic regression is a function that does not have to match exactly with the data points, whereas interpolation is a function that should match exactly with all the data points of a given data set. Isotonic regression is frequently used for prediction and forecasting. Moreover, isotonic regression is different than linear and additive functions because isotonic regression does not assume a line as a target. Rather, it is a minimization of weighted least squares, where every point must be at least as high (or vice versa, as low) as the previous data point. For example, in the event a bucket was being filled with water and ten measurements of the height of water were taken throughout the process of filling, it would be expected that each consecutive measurement would be larger than the prior measurement value. It may be acceptable for a second measurement to be equal to a third measurement in the event that no water was added during the duration of time between the second and third measurement. However, it would be illogical if in the data set of ten measurements, measurements seven and eight are lower than measurement six. This would be implausible to a user collecting the measurements. There could be an explanation for the later measurements to be lower than the prior, such as, the bucket was on a moving device causing the surface of the water in the bucket to fluctuate. Thus, the measurements seven and eight would not be wrong, but would be imprecise. In this scenario, the example pool circuitry 112 would increase measurements seven and eight such that the measurements were no longer decreasing.

Generally speaking, existing approaches use isotonic regression techniques with complicated and/or otherwise relatively high-demand computations, typically requiring graphical processing units (GPUs). For example, typical approaches require relatively high bandwidth data movement from storage to memory to perform isotonic regression calculations. Contrary to traditional techniques, examples disclosed herein apply an approach that involves relatively soft calculations, which can be performed all server side, utilize relatively less sophisticated central processing units (CPUs) (as compared to relatively more sophisticated, expensive, and power-demanding GPUs), and saves energy. In some examples, local data storage 108 is stored on the processor platform(s) 106. While the illustrated example of FIG. 1 shows a single database 102, examples disclosed herein are not limited thereto. For instance, any number and/or type of data storage may be implemented that is communicatively connected to any number and/or type of processor platform(s) 106, either directly and/or via the example network 104.

As described in further detail below, the example environment to improve isotonic regression 100 (and/or circuitry therein) acquires and/or retrieves data to be arranged in a sequential (e.g., chronological, successive, subsequent, etc.) order before analyzing and/or otherwise learning trend and/or pattern information corresponding to the retrieved data. The example processor platform(s) 106 instantiates an executable that relies upon and/or otherwise utilizes one or more circuitries in an effort to complete an objective, such as arranging the acquired data in a sequential (e.g., chronological, successive, subsequent, etc.) order. For example, if fifty data points (e.g., measurements of water height in a bucket, discount offers on products, etc.) were acquired, the example processor platform(s) 106 would arrange (e.g., organize) the fifty data points in a sequential (e.g., chronological, successive, subsequent, etc.) order (e.g., time, increasing discount offers, etc.). The processor platform(s) 106 includes a communication device, such as a transmitter, a receiver, a transceiver, a modem, a residential gateway, a wireless access point, and/or a network interface to facilitate exchange of data with external machines (e.g., computing devices of any kind) by the example network 104. As described in further detail below, the processor platform(s) 106 include the local data storage 108 (e.g., and/or data from any other source(s)), the processing circuitry 110, and the pool circuitry 112 that operate to arrange acquired data to fit a non-decreasing or non-increasing order.

In operation, the example pool circuitry 112 organizes acquired data in a sequential (e.g., chronological, successive, subsequent, etc.) order while arranging violators throughout a regression to reference metrics (e.g., metrics defined by a user and deemed acceptable and/or otherwise industry expected results). In some examples, the data within the database 102 and/or local storage 108 is arranged (e.g., manually) in sequential (e.g., chronological, successive, subsequent, etc.) order before being acquired and/or retrieved. When learning patterns and/or trends, data is acquired and/or retrieved by the pool circuitry 112 and it arranges the data into a sequential (e.g., chronological, successive, subsequent, etc.) order based on a dependent variable (e.g., an ordering variable), such as, time, increasing sale offers, decreasing sale offers, etc. In some examples, the arranged data is expected to be increasing based on the dependent variable. In other instances, the arranged data is expected to be decreasing based on the dependent variable. In addition, the arranged data is expected to fall into predefined intervals, which may vary among data points. The example pool circuitry 112 adjusts (e.g., tightens) the lower interval bounds and the upper interval bounds to define the upper boundary and the lower boundary. The upper interval bound is defined herein as the highest limit (e.g., value) that a particular interval may reach. The lower interval bound is defined herein as the lowest limit (e.g., value) that a particular interval may reach. In some examples, the upper interval bound and the lower interval bound are retrieved along with the retrieved data points. For example, if fifty data points were retrieved corresponding to a time series of water height levels in a bucket, the lower interval bound and the upper interval bound corresponding to each time stamp (interval) would also be retrieved (e.g., as metadata). Further, at an example second time stamp (e.g., interval two), the lower interval bound water level of the bucket may be zero centimeters and the upper interval bound of the water level height is 100 centimeters because that is the height of the bucket. One way the pool circuitry 112 tightens the lower interval bound and the upper interval bound to establish the upper boundary and the lower boundary can be accomplished is through example algorithms represented by example Pseudo Code shown below:

```
l₁l′₁  Pseudo Code 1
      for i ← 2 to n do
            lᵢ ← max(l′ᵢ, lᵢ₋₁)
      end for
uₙ ← u′ₙ  Pseudo Code 2
      for i ← n − 1 down to 1 do
            uᵢ ← min(u′ᵢ, uᵢ₊₁)
                        end for
```

In the illustrated examples of Pseudo Code 1 and Pseudo Code 2, n represents the quantity of acquired data points (e.g., if 50 data points are acquired, then n=50), lᵢ represents the lower boundary, and uᵢ represents the upper boundary.

As shown by example Pseudo Code 1, the algorithm increases each lower bound value to the largest lower bound value which already occurred “before”, that is, for smaller indexes. This is accomplished by defining l₁ as ii, wherein l₁ is a lower interval bound and l′₁ is a lower interval bound at interval one and an externally provided variable. For example, l′₁ may be inputted user data where l₁ is equal to three. The for loop in Pseudo Code 1 takes each data point at each interval, i, and uses a maximum function “max” to compare each lower interval bound, l′ᵢ, to a previous lower interval bound, lᵢ₋₁, from interval two to interval n, wherein n is equal to the quantity of data points. The max function within the for loop of Pseudo Code 1 compares the inputted lower bound value at interval, l′ᵢ, to the previous lower interval bound, lᵢ₋₁, and defines and/or otherwise sets lᵢ with the larger of the two values. For example, if at interval 2 the lower bound value l₂ is equal to four and the inputted lower bound at interval three, l′₃, is equal to two, the max function in Pseudo code 2 would compute the following:

l₃←max(l′₃,l₃₋₁)

l₃←max(2,4)

l₃←4

Here, the max function in Pseudo code 1 increases the lower bound at interval three, l₃, to a value of four. In doing so, example Pseudo Code 1 ensures that the lower bounds are non-decreasing. Furthermore, example Pseudo Code 1 tightens the lower bounds in a significantly faster manner than previous methods that would compare the inputted lower bound at interval, l′ᵢ, to all the previous lower interval bounds. For example, in previous methods the inputted lower bound at interval forty-nine, l′₄₉, would be compared to all forty-eight previous lower interval bounds, which is a computationally demanding operation. In contrast, in example Pseudo Code 1 the inputted lower bound at interval forty-nine, l′₄₉, would be compared to only the lower bound at interval forty-eight, l₄₈. Consequently, examples disclosed herein facilitate energy savings because lower interval bounds are tightened while consuming fewer computational resources.

Correspondingly, example Pseudo Code 2 decreases each upper bound to the lowest upper bound which occurs “later”, that is, for larger indexes. This is accomplished by defining uₙ as u′ₙ, wherein uₙ is the upper interval bound and u′ₙ is a upper interval bound at a last data point and an externally provided variable. For example, u′ₙ, may be inputted user data at interval fifty where u′₅₀ is equal to one hundred. The for loop in Pseudo Code 2 takes each data point at each interval, i, and uses a minimum function “min” to compare each upper interval bound, u′ᵢ, to a later upper interval bound, uᵢ₊₁, from interval n−1 to interval 1, wherein n is equal to the quantity of data points. The min function within the for loop of example Pseudo Code 2 compares the inputted upper bound at interval, u′ᵢ, to the later upper interval bound, uᵢ₊₁, and defines uᵢ with the smaller of the two values. For example, if at interval fifty the upper bound u₅₀ is equal to a value of one hundred and the inputted upper bound at interval forty-nine, l′₄₉, is equal to a value of one hundred and twenty, the min function in Pseudo code 2 would compute the following:

u₄₉←min(u′₄₉,u₄₉₊₁)

u₄₉←min(120,100)

u₄₉←100

Here, the min function in example Pseudo code 2 reduces the upper bound value at interval forty-nine, u₄₉, to a value of one hundred. In doing so, example Pseudo Code 2 ensures that the upper bound values are non-decreasing. Furthermore, example Pseudo Code 2 tightens the upper bound values in a significantly faster manner than previous methods that would compare the inputted upper bound at interval, u′ᵢ, to all the previous later interval bounds. For example, in previous methods the inputted upper bound at interval one, u′₁, would be compared to all forty-nine later upper interval bounds in a data set of fifty data points. In contrast, in Pseudo Code 2 the inputted upper bound at interval one, u′₁, would only be compared to the upper bound at interval two, u₂. Consequently, examples disclosed herein facilitate energy savings because upper interval bounds are tightened while consuming fewer computational resources.

Additionally, the example pool circuitry 112 checks the consistency of the acquired data. As defined herein “consistent” acquired data represents circumstances where all the lower interval bounds have a lower limit than the respective upper interval bounds. For example, consistent data would be evident if the lower interval bound at interval four is five centimeters and the upper interval bound at interval four is ten centimeters. As defined herein “inconsistent” acquired data represents circumstances where the lower interval bounds have a higher limit than the upper interval bound. For example, inconsistent data would be evident if the lower interval bound at interval four is nine centimeters and the upper interval bound at interval four is eight centimeters. This would be illogical because the lower limit is greater than the upper limit. In some examples, the pool circuitry 112 prevents the wasting of computational resources by ending the operation if the acquired data is deemed inconsistent. In some examples, the pool circuitry 112 prevents model training when the data is deemed inconsistent. In other examples, the pool circuitry 112 maintains model training when the data is consistent.

One example manner in which the pool circuitry 112 checks consistency is accomplished is in a manner consistent with example Pseudo Code 3:

```
for i ← 1 to n do  Pseudo Code 3
      if lᵢ > uᵢ then
            stop, the problem is inconsistent.
      end if
end for
```

To check the consistency, example pool circuitry 112 evaluates, for all acquired data points 1 to n, if the lower bound interval, lᵢ, is greater than the upper bound interval, uᵢ. In some examples, if the lower bound interval, lᵢ, is greater than the upper bound interval, uᵢ, the pool circuitry 112 determines that the interval bounds are illogical (e.g., inconsistent) and the pool circuitry 112 will end the for loop in a manner consistent with example Pseudo Code 3. In some examples, a problem is “inconsistent” if it has no solution. For example, a problem might require a non-decreasing set of data with a first data point to be no smaller than five, and a second data point to be no larger than three. Clearly, it is impossible to find two non-decreasing data points so that the first data point has at least the value five and the second data point has at most the value three.

As described above, early identification of such circumstances in which data to be analyzed is inconsistent and/or otherwise unsolvable allows examples disclosed herein to conserve computing resources and time that would otherwise be consumed by traditional techniques that continue to attempt solutions.

If the problem is consistent when, for example, all upper interval bounds, uᵢ, are larger than the respective lower interval bounds, lᵢ, then the example pool circuitry 112 pulls a first data point and confirms that the first data point is within the interval lower and upper bound. If the first data point is not within the interval lower and upper bounds, the example pool circuitry 112 calculates a new first data point value to fit within the interval lower and upper bounds. For example, if the first data point is below the interval lower bound, the pool circuitry 112 increases its value to hit the lower bound in a manner consistent with example Pseudo Code 5, described further below. If it is above the upper bound, the pool circuitry 112 decreases its value to meet the upper bound using in a manner consistent with example Pseudo Code 5, further described below. The pool circuitry 112 then compares each consecutive data point to the previous data point. If the consecutive data point is not equal or larger than the previous data point (or smaller in some scenarios) the pool circuitry 112 calculates a new value for the consecutive and previous data point. An example manner facilitated by the pool circuitry 112 to compare the consecutive data point to the previous data point and calculate the new value can be accomplished in a manner consistent with example Pseudo Code 4:

```
s ← 0 Pseudo Code 4
for i ← 1 to n do
  s ← s + 1
  Lₛ ← lᵢ
  x̅ₛ^{o} ← x̅ᵢ^{o}
  Uₛ ← uᵢ
  Wₛ ← wᵢ
  Nₛ ← 1
  while s > 1
  and min(max(Lₛ, x̅ₛ^{o}), Uₛ) ≤ min(max(Lₛ₋₁, x̅ₛ₋₁^{o}), Uₛ₋₁) do
    Lₛ₋₁ ← Lₛ
    Wₛ₋₁ ← Wₛ₋₁ + Wₛ
    ${\overline{x}}_{s - 1}^{o} ← {\overline{x}}_{s - 1}^{o} + {W}_{s} \cdot \frac{{\overline{x}}_{s}^{o} - {\overline{x}}_{s - 1}^{o}}{{W}_{s - 1}}$
    Nₛ₋₁ ← Nₛ₋₁ + Nₛ
    s ← s − 1
  end while
end for
```

In the above example Pseudo Code 4, the code begins with a for-loop from interval one to n, which represents the quantity of retrieved data. The variable ‘s’ represents the number of subsets of considered data points. Hence, Pseudo Code 4 starts at zero and is raised to one when the Pseudo Code 4 analyzes each data point, x̅ₛ^{o}, which are defined by the inputted data points xᵢ^{o}. A variable Lₛ is defined by the lower boundary lᵢ from Pseudo Code 1 and a variable Uₛ is defined by the upper boundary uᵢ from Pseudo Code 2. A variable Wₛ is defined by a weight at each data point, wᵢ. In some examples, the weight at each data point, wᵢ, is set at one. In other examples, the weight at a certain data point, wᵢ, is set to less than one if the data point is an outlier. For example, if a set of fifty data points included mostly single digit numbers, however, one of the fifty data points is five hundred, the weight, wᵢ, for the data point with the value five hundred, may be set to 0.5 so the outlier has less impact on the final solution. In the Pseudo code 4 for-loop, a variable Nₛ, which represents a quantity of pooled data points within a subset, is set to one before entering the while loop. In example Pseudo code 4, the outer for-loop considers each data point alongside its corresponding interval bounds.

Next, example Pseudo Code 4 enters the inner while-loop, if and only if, it decided to “pool” (e.g., average) the current data point with the most recent subset of averaged data points. As mentioned previously, the variable “s” is counting the number subsets of considered data points, xᵢ^{o}. If the variable “s” initial value is 0, then “s” is increased whenever a new data point is considered. Example Pseudo code 4 only enters the while-loop if the value of “s” is greater than one. For example, Pseudo Code 4 will not enter the while-loop when the first data point is being considered because “s” would be equal to 1. However, pseudo code 4 may enter the while-loop when the second data point is being considered because “s” would be equal to 2. However, before entering the while-loop Pseudo Code 4 will additionally analyze whether the minimum of the data point being examined, x̅ₛ^{o}, while considering the upper and lower boundary at the data point being examined, is less than or equal to a previous data point, x̅ₛ₋₁^{o}, while considering the upper and lower bound at the previous data point.

The pool circuitry 112 decides whether to pool the current data point using Pseudo Code 4 line 10. If the value of “s” is greater than one and the data point, x̅ₛ^{o}, being considered is less than the previous data point, x̅ₛ₋₁^{o}, while considering the upper and lower boundary then pool circuitry 112 pools the data points x̅ₛ^{o} and x̅ₛ₋₁^{o}. The example pool circuitry 112 pools the two data points x̅ₛ^{o} and x̅ₛ₋₁^{o}, by averaging the two data points using the equation,

$${\overline{x}}_{s - 1}^{o} ← {\overline{x}}_{s - 1}^{o} + {W}_{s} \cdot \frac{{\overline{x}}_{s}^{o} - {\overline{x}}_{s - 1}^{o}}{{W}_{s - 1}} .$$

Here, x̅ₛ₋₁^{o} new value is calculated by x̅ₛ₋₁^{o} plus the weight, Wₛ, multiplied by the difference between the data points x̅ₛ^{o} and x̅ₛ₋₁^{o} divided by a weight, Wₛ₋₁. The weight, Wₛ₋₁, is calculated in the while-loop by a previous weight, Wₛ₋₁, plus the current weight, Wₛ. For example, if the weight at data point two, W₂, is equal to 1 and the weight at the previous data point, W₂₋₁, is equal to 1, then the weight, Wₛ₋₁, in the while-loop is equal to 2. In the example where data point one, x̅ₛ₋₁^{o}, is equal to two and data point two, x̅ₛ^{o}, is equal to one, example Pseudo Code 4 while-loop computes the following:

$${W}_{s - 1} ← 1 + 1$$

$${\overline{x}}_{s - 1}^{o} ← 2 + 1 \cdot \frac{1 - 2}{2}$$

$${\overline{x}}_{s - 1}^{o} ← 1.5$$

In this example, the pool circuitry 112 pools the data points x̅ₛ^{o} and x̅ₛ₋₁^{o}, which were equal to 1 and 2, respectively, to obtain a non-decreasing number, 1.5. In the example the while-loop is entered, the new data point does not initiate a new subset, s, instead it is merged with the most recent subset. Therefore, the pool circuitry 112 decrements the variable “s,” in Pseudo Code 4 while-loop, to one by subtracting one from the variable “s.” Here, by decrementing the value of “s” back to one, pool circuitry 112 ensures that only the previous data point, x̅ₛ₋₁^{o}, is analyzed instead of analyzing all previous data points. Further, variable Nₛ represents the quantity of pooled data points within subsets, s.

After the pool circuitry 112 compares all consecutive data points to the previous data points (e.g., a last data point is compared to a second to last data point), the example pool circuitry 112 establishes a minimizer, x*ᵢ, from the interim results. The minimizer refers to the uniquely determined list of non-decreasing numbers which fall into the interval bounds, and whose sum of squared differences to the original data points is minimal. One way the pool circuitry 112 establishes the minimizer from the interim results is through example Pseudo Code 5 represented below:

```
i ← 1 Pseudo Code 5
for k ← 1 to s do
      for j ← 1 to Nₖ do
            xᵢ* ← min(max(Lₖ, x̅ₖ^{o}) , Uₖ)
            i ← i + 1
      end for
                        end for
```

Here, variable “k” iterates through the subsets of averaged data points, s. As stated previously in Pseudo Code 4, variable “s” represents the number of the subsets of averaged data points. Pseudo Code 5 enters a first for-loop that iterates through all variables “s” that are subsets of averaged data points from Pseudo Code 4 above, and ensures the averaged data point, x̅ₖ^{o}, falls within the upper and lower boundaries, Lₖ and Uₖ. Example Pseudo Code 5 enters a second for-loop that iterates through variable “j” starting at 1 and iterates through all variables “Nₖ” that represent a quantity of pooled data points within each subset. For example, if Pseudo Code 4 pools data points 1, 2, 3, and 4 to single value, then Nₖ is equal to four. From the two for-loops, the minimizers, x*ᵢ, are established. The minimizers, x*ᵢ, are calculated by the minimum of the upper boundary and the maximum of the lower boundary compared to the averaged data point, x̅ₖ^{o}, established in Pseudo Code 4. For example, if the value of the averaged data point, x̅ₖ^{o}, is equal to 1.5, the upper and lower boundaries, Lₖ and Uₖ, equal to 0 and 4, respectively, the pool circuitry 112 would calculate the following:

x*ᵢ←min(max(Lₖ,x̅ₖ^{o}),Uₖ)x*ᵢ←min(max(0,1.5),4)

x*ᵢ←1.5

Here, example Pseudo Code 5 ensures that the minimizer is within the lower and upper boundaries, Lₖ and Uₖ. If the averaged data point, x̅ₖ^{o}, below the lower boundary, the pool circuitry 112 raises the value to hit the lower boundary, Lₖ. If the averaged data point, x̅ₖ^{o}, is above the upper boundary, Uₖ, the pool circuitry 112 lowers the value to hit the upper boundary, Uₖ. Thus, each minimizer, x*ᵢ, is within the lower and upper boundaries, Lₖ and Uₖ. After example Pseudo Code 5 is completed, the set of acquired data points no longer violate the constraints and have been corrected (e.g., revised, augmented, replaced, etc.) with minimizers.

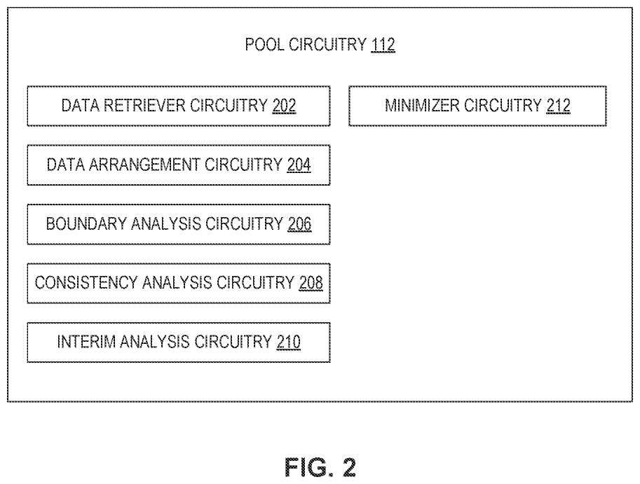

FIG. 2 is a schematic illustration of example pool circuitry 112 to improve isotonic regression. The example pool circuitry 112 includes example data retriever circuitry 202, example data arrangement circuitry 204, example boundary analysis circuitry 206, example consistency analysis circuitry 208, example interim analysis circuitry 210, and example minimizer circuitry 212. The example pool circuitry 112 of FIG. 2 may be instantiated (e.g., creating an instance of, bring into being for any length of time, materialize, implement, etc.) by processor circuitry such as a central processing unit executing instructions. Additionally or alternatively, the example pool circuitry 112 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

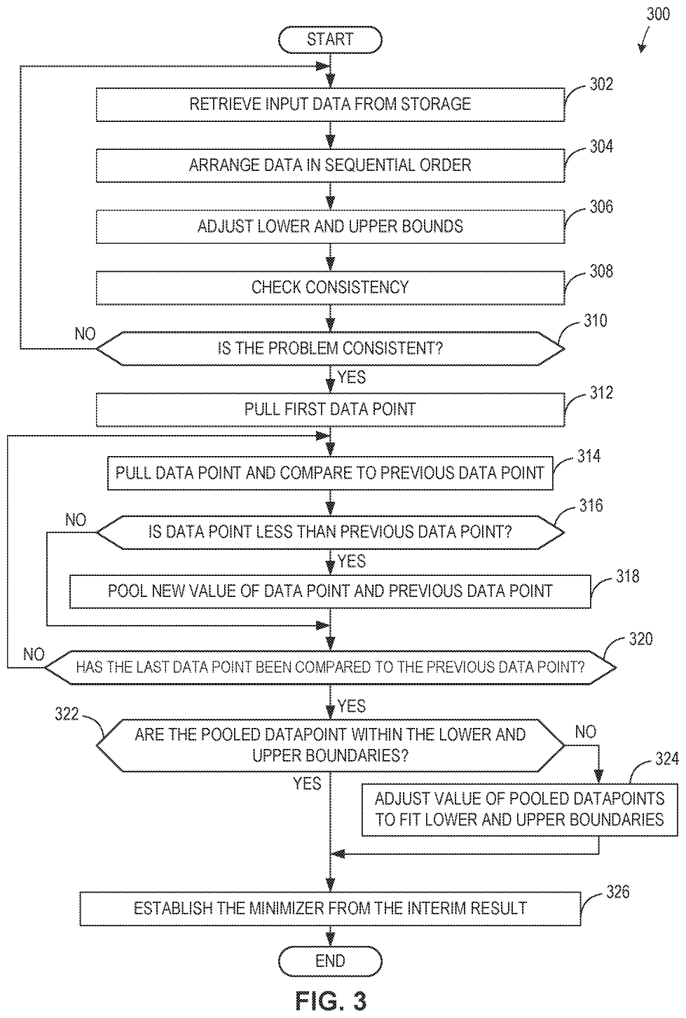

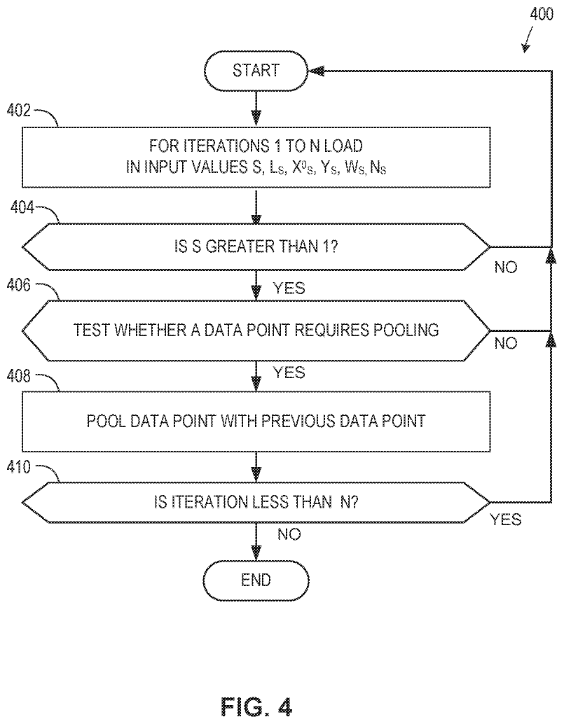

The example pool circuitry 112 includes data retriever circuitry 202 that retrieves data from the database 102. The database 102 may be implemented as any type of storage device (e.g., cloud storage, local storage, or network storage). In some examples, the data retriever circuitry 202 is instantiated by processor circuitry executing data retriever instructions and/or configured to perform operations such as those represented by the flowcharts of FIGS. 3-4, discussed in further detail below. The pool circuitry 112 also includes data arrangement circuitry 204 to arrange the retrieved data in sequential (e.g., chronological, successive, subsequent, etc.) order. In some examples, the data arrangement circuitry 204 is instantiated by processor circuitry executing data arrangement instructions and/or configured to perform operations such as those represented by the flowcharts of FIGS. 3-4. Additionally, the example pool circuitry 112 includes the boundary analysis circuitry 206 to check lower interval bounds and upper interval bounds of input data and, when appropriate, adjusts values to conform to one or more rules and/or expectations. In some examples, the boundary analysis circuitry 206 is instantiated by processor circuitry executing boundary analysis instructions and/or configured to perform operations such as those represented by the flowcharts of FIGS. 3-4, discussed in further detail below.

While one or more interval lower bounds and/or upper bounds may be checked, the pool circuitry 112 includes the example consistency analysis circuitry 208 that verifies and/or otherwise ensures that overall boundaries are within reason and/or otherwise logically consistent. In some examples, the example consistency analysis circuitry 208 determines that the retrieved data is incapable of yielding a solution and, if so, the consistency analysis circuitry 208 causes the analysis to stop so that further computational resources are not wasted. For example, a problem that requires a non-increasing set of data with a first data point to be no larger than five, and a second data point to be no smaller than six. Thus, the retrieved data is incapable of yielding a solution because it is impossible to find two non-increasing data points so that the first data point has at most the value five and the second data point has at least the value six. In some examples, the boundary analysis circuitry 206 is instantiated by processor circuitry executing consistency analysis instructions and/or configured to perform operations such as those represented by the flowcharts of FIGS. 3-4, discussed in further detail below.

The pool circuitry 112 includes the example interim analysis circuitry 210 to compute any number of interim qualities, and the minimizer circuitry 212 applies the interim qualities to determine and/or generate an improved solution. In some examples, the pool circuitry 112 calculates and/or generates the interim results (e.g., s, Nₖ, Lₖ, Uₖ, and xₖ^{o}) in a manner consistent with example Pseudo Code 4 above. Most of the interim results with lower indexes are transformed into the minimizer, xᵢ*, the result. In some examples, the interim analysis circuitry 210 and the minimizer circuitry 212 is instantiated by processor circuitry executing interim analysis and minimizer instructions and/or configured to perform operations such as those represented by the flowcharts of FIGS. 3-4, discussed in further detail below.

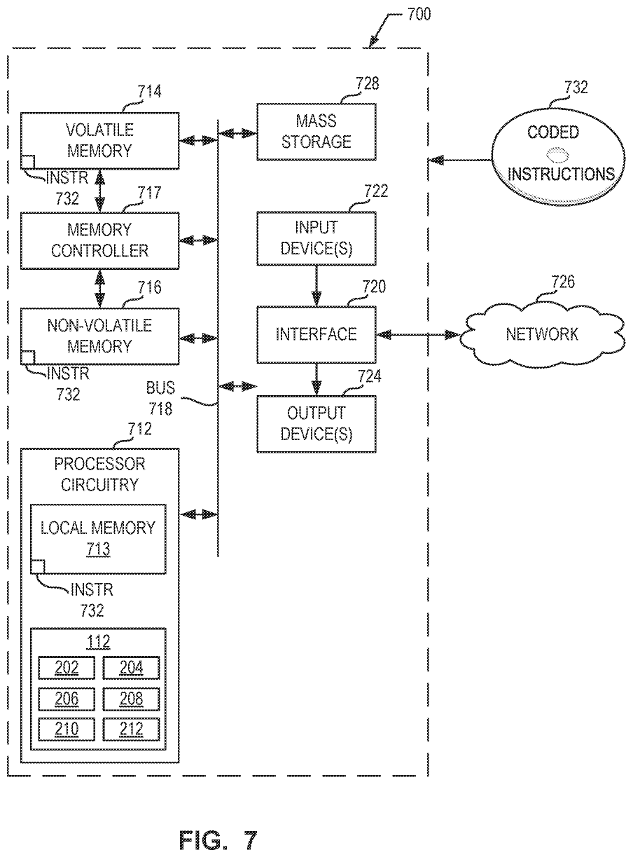

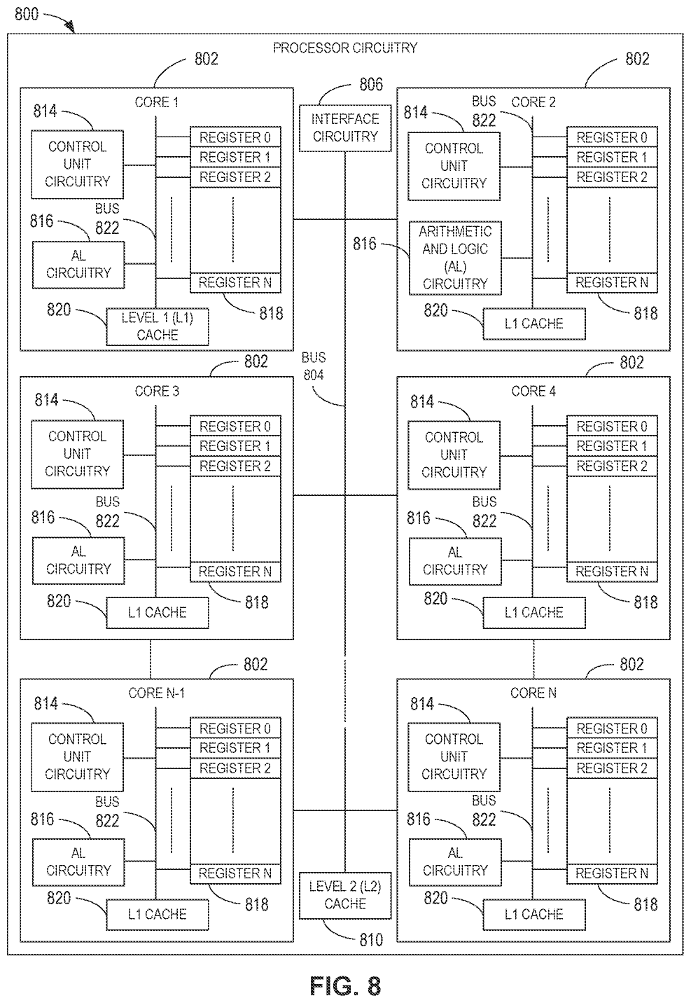

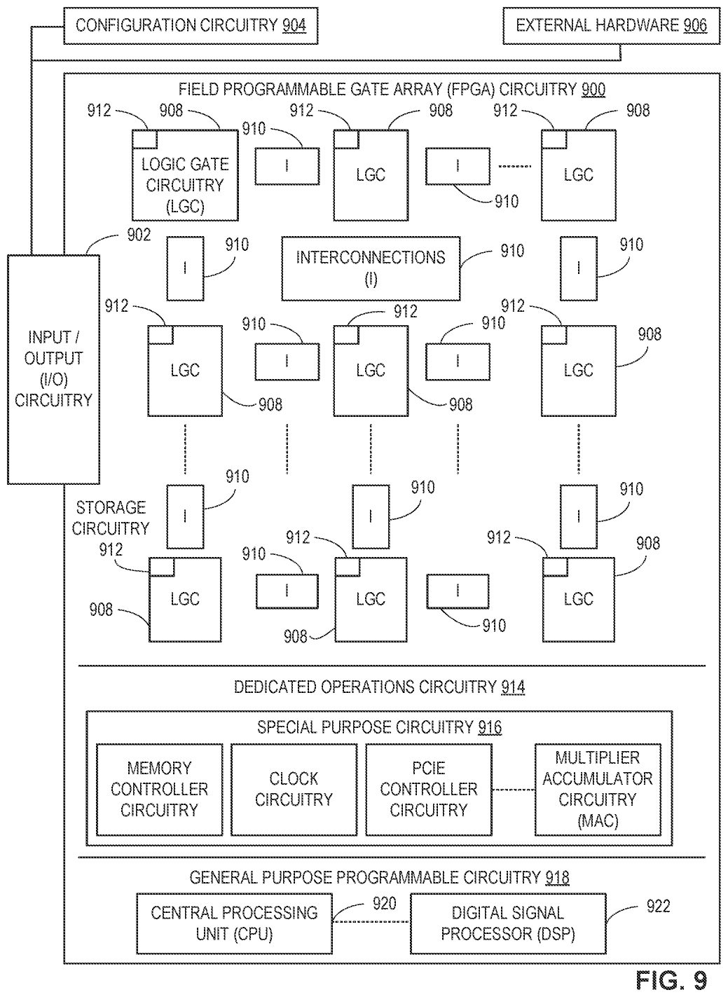

In some examples, the pool circuitry 112 includes means for data retrieving, means for arranging data, means for establishing boundaries, means for analyzing consistency, means for analyzing interim values, and means for establishing the minimizer. For example, the means for retrieving data may be implemented by the data retriever circuitry 202, the means for arranging data may be implemented by the data arrangement circuitry 204, the means for establishing boundaries may be implemented by the example boundary analysis circuitry 206, the means for analyzing consistency may be implemented by the example consistency analysis circuitry 208, the means for analyzing interim values may be implemented by the example interim analysis circuitry 210, and the means for establishing the minimizer may be implemented by the example minimizer circuitry 212. In some examples, the aforementioned circuitry may be instantiated by processor circuitry such as the example processor circuitry 712 of FIG. 7. For instance, the aforementioned circuitry may be instantiated by the example microprocessor 800 of FIG. 8 executing machine executable instructions such as those implemented by one or more blocks of FIGS. 3-4. In some examples, the aforementioned circuitry may be instantiated by hardware logic circuitry, which may be implemented by an ASIC, XPU, or the FPGA circuitry 900 of FIG. 9 structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the example pool circuitry 112 of FIG. 2 is illustrated in FIGS. 3-4, one or more of the elements, processes, and/or devices illustrated in FIG. 2 may be combined, divided, re-arranged, omitted, eliminated, and/or implemented in any other way. Further, the example data retriever circuitry 202, the example data arrangement circuitry 204, the example boundary analysis circuitry 206, the example consistency analysis circuitry 208, the example interim analysis circuitry 210, and the example minimizer circuitry 212, and/or, more generally, the example pool circuitry 112 of FIG. 2, may be implemented by hardware alone or by hardware in combination with software and/or firmware. Thus, for example, any of the example data retriever circuitry 202, the example data arrangement circuitry 204, the example boundary analysis circuitry 206, the example consistency analysis circuitry 208, the example interim analysis circuitry 210, and the example minimizer circuitry 212, and/or, more generally, the example pool circuitry 112 of FIG. 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example pool circuitry 112 of FIG. 2 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed to configure processor circuitry to implement the pool circuitry 112 of FIG. 2, are shown in FIGS. 3-4. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIGS. 8 and/or 9. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 3-4, many other methods of implementing the example pool circuitry 112 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to pool adjacent violators. As described above, adjacent violators are data points near and or close to an acceptable data point that violate constraints or violate a non-increasing or non-decreasing trend rules, for example. Non-violators are data points near or close to an acceptable data point that do not violate constraints or violate a non-increasing or non-decreasing trend rules. For instance, if a pool was being drained and the level of water was being recorded on a time schedule, and the pool water level at the first-time interval was eight feet but at the second time interval the water level was nine feet, the second time interval is an example of an adjacent violator. The second time interval measurement of nine feet would be non-decreasing water level height from the previous acceptable data point of eight feet at time interval one. Furthermore, if the pool is being drained of water, then all successive and/or subsequent data points are expected to be non-increasing. Thus, the water level measuring a foot higher at the second time interval than the first-time interval is illogical or an adjacent violator, for example.

The machine readable instructions and/or the operations 300 of FIG. 3 begin at block 302, at which the example data retriever circuitry 202 retrieves and/or acquires data from storage (e.g., database, local storage, etc.). In some examples, retrieved and/or acquired data are the quantity of product sales per day corresponding to increasing sale offers. For example, if chocolate bars at a gas station were on sale for five percent off on day one, ten percent off on day two, and fifteen percent off on day three, then the retrieved data, for this scenario, would be the total quantity of chocolate bars sold, respectively, on day one, two, and three. Additionally, the lower interval bounds, and upper interval bounds are also included in the retrieved data. For instance, on day one the lower interval bound may be zero chocolate bars sold and the upper interval bound would be equal to the total quantity of chocolate bar in stock at the gas station. In other instances, the retrieved and/or acquired data can represent the amount of traffic a website receives based on quantity of advertisements.

The example arrangement circuitry 204 arranges (e.g., organizes, assembles, orders, etc.) the retrieved data into sequential (e.g., chronological, successive, subsequent, etc.) order (block 304). In some examples, it is necessary to arrange the retrieved data because the retrieved data may not be in a sequential (e.g., chronological, successive, subsequent, etc.) order. For example, if thirty days of data were retrieved from the database, and the thirty data points are mixed together in such a way that on a list of all thirty data points, data point twenty-five comes before data point four, then the example arrangement circuitry 204 would arrange (e.g., organize, assemble, order, etc.) such that the list read from data point one to data point thirty.

The boundary analysis circuitry 206 retrieves bounds data and/or otherwise adjusts the lower interval bounds of the retrieved data, and checks for and/or otherwise adjusts the upper interval bounds of the retrieved data to establish the lower boundary and the upper boundary, respectively (block 306). In some examples, the lower boundary is established in a manner consistent with Pseudo Code 1 and the upper boundary is established in a manner consistent with Pseudo Code 2.

The example consistency analysis circuitry 208 checks rules corresponding to consistency expectations (block 308), and if there is an inconsistency that cannot be resolved (block 310), the example process 300 of FIG. 3 loops back to block 302. For example, in a scenario where the amount of chocolate bars sold in a gas station is being tracked, if on day three the lower interval bound is equal to one hundred chocolate bars and the upper interval bound on day three is equal to seventy-five chocolate bars, then there is an inconsistency that cannot be resolved because the lower interval bound cannot exceed the upper interval bound. However, in some examples, the inconsistency may be resolved. For example, if the total amount of chocolate bars in stock at the gas station is equal to one hundred and twenty-five, then the upper interval bound on day three may be adjusted from seventy-five to one hundred and twenty-five. In some examples, in response to the consistency analysis circuitry 208 determining that retrieved data is inconsistent (block 310), the analysis circuitry 208 prohibits, prevents and/or otherwise blocks further computational analysis of the retrieved data.

On the other hand, if the example consistency analysis circuitry 208 determines that the problem is consistent (block 310), then the example interim analysis circuitry 210 pulls the first data point (block 312). The example interim analysis circuitry 210 pulls each consecutive data point and compares the consecutive data point to the previous data point (block 314). If the consecutive data point is less than the previous data point (block 316), the example interim analysis circuitry 210 pools and/or calculates a new value of consecutive data point a previous data point (block 318). If the consecutive data point is not less than the previous data point (block 316), the example interim analysis circuitry 210 advances to block 320 and tests whether the last data point has been compared to the previous data point. In other words, if the consecutive data point is equal to or more than the previous data point, the example interim analysis circuitry 210 advances to block 320 and tests whether the last data point has been compared to the previous data point. If the last data point has not been compared to the previous data point, then the example interim analysis circuitry 210 loops back to block 314 to pull the next consecutive data point. If the last data point has been compared to the previous data point, the example minimizer circuitry 212 iterates through the pooled data points and tests whether the pooled data points are within the lower and upper boundaries (block 322). If the pooled data points are not within the interval lower boundary and upper boundary, the example minimizer circuitry 212 adjusts the pooled data points to fall within the interval lower boundary and upper boundary. For example, if the pooled data points are below the interval lower boundary, the example minimizer circuitry 212 increases the pooled data points values to hit the lower boundary using the example Pseudo Code 5. In some examples, if it is above the upper boundary, the minimizer circuitry 212 decreases its value to hit the upper boundary using the example Pseudo Code 5. If the pooled data points are within the interval lower and upper boundaries, establishes and/or generates minimizers from the interim results (block 326). Thereafter, the adjacent violators are pooled, and the minimizers are in a non-decreasing arrangement, thus, the example operations 300 are concluded.

Stated differently, examples disclosed herein pool adjacent violators in isotonic regression problems while keeping the data point values close to a sequence of observations while using soft computations to remedy unexpected and/or illogical decreasing or increasing data. Isotonic regression is advantageous in many applications as opposed to other approaches like linear regression, averaging or interpolation. For example, in many applications, correcting measurement errors to arrive at a non-decreasing dataset can soundly be justified from subject matter understanding, while a linear trend of such data cannot. In such instances, isotonic regression is better suited to the problem than linear regression. Mere averaging of data points can be interpreted as a constant solution, which again is a much stricter assumption than non-decreasing solutions. Moreover, interpolation does not change observed data points, it is a method of constructing new data points based on a range of a discrete set of known data points Thus, interpolation is inadequate when dealing with situations where subject matter understanding dictates that data without measurement errors should be non-decreasing and/or non-increasing. Generally speaking, current implementations of solving isotonic regression problems require moving data into memory to perform calculations and include unnecessary data points. As such, energy savings results by avoiding computationally intensive isotonic regression solutions and replacing them with pooling data points and soft computations. Moreover, the examples disclosed herein solve isotonic regression problems about twenty times faster than traditional techniques.

FIG. 4 is another flowchart representative of example machine readable instructions and/or example operations 400 that may be executed and/or instantiated by processor circuitry to pool adjacent violators. The machine readable instructions and/or the operations 400 of FIG. 4 begin at block 402, at which the example data retriever circuitry 202 inputs, retrieves and/or acquires data from storage (e.g., database, local storage, etc.) for variables s, Lₛ, Uₛ, x̅ₛ^{o}, Wₛ, and Nₛ, (defined above in Pseudo Code 4 description) for each iteration 1 to n, the quantity of retrieved data. In some examples, these variables are calculated using Pseudo Codes 1, 2, and 4. In some examples, these variables are provided data. The example interim analysis circuitry 210 then tests if the variable s is greater than 1 (block 404). In some examples, the example variable s is calculated consistent with Pseudo Code 4. As mentioned previously, Pseudo Code 4 begins with s equal to zero and is increased by one for iterations 1 to n. If s is not greater than 1, then the interim analysis circuitry 210 returns to block 402 and the example data retriever circuitry 202 is initiated to load input values for the next iteration. If s is greater than 1, then the interim analysis circuitry 210 test and/or analyzes whether a data point requires pooling (block 406). If the data point does not require pooling, the example interim analysis circuitry 210 returns to block 402 and initiates the data retriever circuitry 202 to load the next iteration. If the data point does require pooling, the example interim analysis circuitry 210 pools, described in further detail below, the data point with the previous data point (block 408).

In some examples, the interim analysis circuitry 210 test and/or analyzes whether the minimum of the data point being examined, x̅ₛ^{o}, while considering the upper and lower boundaries at the data point being examined, is less than or equal to a previous data point, x̅ₛ₋₁^{o}, while considering the upper and lower boundaries at the previous data point. In some examples, this is consistent with Pseudo Code 4. For example, if the current data point being examined, x̅ₛ^{o}, is equal or greater than the previous data point, x̅ₛ₋₁^{o}, while considering the lower and upper boundaries, then the example interim analysis circuitry 210 returns to block 402 and initiates the data retriever circuitry 202 to load the next iteration. If the current data point being examined, x̅ₛ₋₁^{o}, is less than the previous data point, x̅ₛ₋₁^{o}, while considering the lower and upper boundaries, then the interim analysis circuitry 210 pools and/or averages the two data points x̅ₛ^{o} and x̅ₛ₋₁^{o}, by averaging the two data points using the equation,

$${\overline{x}}_{s - 1}^{o} ← {\overline{x}}_{s - 1}^{o} + {W}_{s} \cdot \frac{{\overline{x}}_{s}^{o} - {\overline{x}}_{s - 1}^{o}}{{W}_{s - 1}} .$$

Here, x̅ₛ₋₁^{o} new value is calculated by x̅ₛ₋₁^{o} plus the weight, Wₛ, multiplied by the difference between the data points x̅ₛ^{o} and x̅ₛ₋₁^{o} divided by a weight, Wₛ₋₁. Additionally, the interim analysis circuitry 210 keeps a count of the quantity of pooled data points within each subset, Nₛ₋₁, and decrements the variable s, to one by subtracting one from the variable s. Here, by decrementing the value of s back to one, the example interim analysis circuitry 210 guarantees that only the previous data point, x̅ₛ₋₁^{o}, is analyzed instead of analyzing all previous data points. Traditional approaches would analyze all previous data points, thus requiring more computations and/or additional analysis. Examples described herein create efficiency gains by reducing the amount of required computations and/or analysis because the interim analysis circuitry guarantees that only the previous data point, x̅ₛ₋₁^{o}, by averaging the subset of data points to establish a pooled data point value, which is analyzed in lieu of analyzing all previous data points.

The interim analysis circuitry 210 then tests whether the iteration being examined is less than n, the quantity of retrieved data (block 410). Although the example described above refers to non-decreasing examples, the examples herein shall not be limited thereto. In some examples, the codes are modified to apply to non-increasing examples.

Generally speaking, current implementations of solving isotonic regression problems do not consider the lower and upper boundary constraints when pooling the adjacent violators. The pool circuitry 112 decides whether to pool the current data point by analyzing whether the current minimum upper bound value and maximum lower bound value is less than or equal to the previous minimum upper bound value and maximum lower bound value while also considering the current data point value to the previous data point value. Including the upper and lower boundaries in the pooling analysis and only analyzing the previous bound constraints increases the speed of solving isotonic regression problems, resulting in green energy savings.

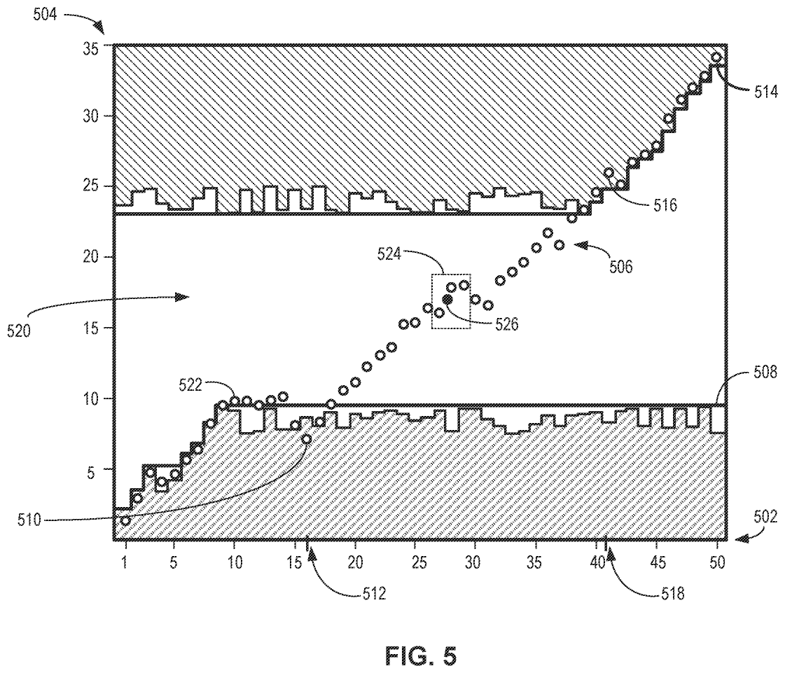

FIG. 5 is a graph of an example fifty data points prior to the pool circuitry 112 of FIG. 2 optimizing isotonic regression. As shown in FIG. 5, an x-axis 502 is defined by an interval, i. In some examples, the interval represents the amount of time between two given data points (e.g., times and/or offers (e.g., the amount of time that has passed between taking a first measurement and a second measurement, a difference between a first sale offer and a second sale offer, etc.)). A y-axis 504 on the graph is defined by measurements (e.g., values, quantities, rates, etc.) recorded at each interval, i, 502. The illustrated example of FIG. 5 includes a quantity, n, of fifty retrieved and/or acquired data points, xᵢ^{o}, 506, arranged in accordance with the intervals, i, 502. In some examples, the fifty retrieved data points, xᵢ^{o}, 506 are obtained from a database or a local storage. An example lower boundary 508, lᵢ, is represented by a solid black line. In some examples, the lower boundary 508, lᵢ, is a lower limit which the fifty retrieved data points, xᵢ^{o}, 506, graphed at each of the fifty intervals, i, 502, are constrained to lie above. In other words, the fifty retrieved data points, xᵢ^{o}, 506 graphed at each of the fifty intervals, i, 502, based on predicted values are constrained to lie above the lower boundary 508, lᵢ. However, due to measurement problems and random error some data points lie below the lower boundary 508, lᵢ, causing a decreasing trough on the graph. For example, a data point sixteen 510 at an interval sixteen 512 is below the lower boundary 508, lᵢ. Frequently, the previous way the illogical data point sixteen 510 was dealt with would have been to throw it out and/or discard it. However, this is not the best option because there may be important information to learn from data point sixteen 510 and throwing it out completely would prevent the ability to consider at least some of its influence on the entire data set. For example, if the data points on the graph represent the number of visits a website receives in a day corresponding to an increasing number of website advertisements, it would be expected that as the number of advertisements increases the number views should be non-decreasing. However, the interval sixteen 512 lines up with a three-day hurricane that knocked out the power/communication/internet so that consumers could not browse the internet and the advertisements could not be received. Throwing out the data point sixteen 510 would skew the data to wrongly favor a much steeper slope on the isotonic regression graph. The example pool circuitry 112 pools this adjacent violator (data point sixteen 510) close to the adjacent acceptable data points, such as, interval thirteen or twenty. Thus, example isotonic regression models disclosed herein do not improperly throw away important information, such as, natural disasters affecting the views a website receives, and wrongly favor a steeper increase in the regression.

Additionally, examples described herein take the illogical data point sixteen 510 and compare it only to the previous subset and/or data point. Traditional approaches would take data point sixteen 510 and analyze it against every previous data point. For example, traditional approaches would compare data point sixteen 510 to fifteen previous data points. The examples disclosed herein promote efficiency gains by requiring less comparative analysis and/or computations than previous solutions.

Furthermore, an upper boundary 514 is illustrated by a solid black line, as shown in the upper section of the graph. In some examples, the upper boundary 514, uᵢ, is an upper limit which the fifty retrieved data points, xᵢ^{o}, 506, graphed at each of the fifty intervals, i, 502, are constrained to lie below. In other words, the fifty retrieved data points, xᵢ^{o}, 506 graphed at each of the fifty intervals, i, 502, based on predicted values are constrained to lie below the upper boundary 514, uᵢ. However, due to measurement problems and random error, some data points lie above the upper boundary 514. For example, a data point forty-one 516 at an interval forty-one 518 is above the upper boundary 514, uᵢ. The lower boundary 508, lᵢ, and the upper boundary 514, uᵢ, define a valid area 520, as illustrated in the graph by the white region, wherein all retrieved data points, xᵢ^{o}, 506 are predicted to fall within. In some examples, the lower boundary 508, lᵢ, and the upper boundary 514, uᵢ, are calculated in accordance with Pseudo Code 1 and Pseudo Code 2, respectively.

In some instances, the retrieved data, xᵢ^{o}, of fifty data points, n, 506 represent expected sales based on increasing discounts starting at 1% discount and ending at interval, i, with a 50% discount. It would be expected that, based on the increasing discounts, the sales should be increasing. However, due to measurement problems, random error, or in some instances, a holiday in which retail stores are closed, data point ten 522 (sales recorded at 10% discount) is greater than the sale recorded at the data point sixteen 510 (sales recorded at 16% discount). To remedy this error, examples disclosed herein apply one or more techniques to pool adjacent vectors. In other words, the example pool circuitry 112 inspects data points and if it finds a point that violates constraints, the pool circuitry 112 pools the value with adjacent data points. For example, data points between interval twenty-four and interval thirty-two include a set of three data points 524. Within the set of three data points 524 there are retrieved data, xᵢ^{o}, 606 which violate constraints (e.g., decreasing sales at an increasing discount offer). To remedy this violation the pool circuitry 112 pools the three data points 524 and replaces the three data points 524 with a single improved point 526. As described previously, the single improved point 526 changes the input data points as little as necessary, while satisfying both the interval bounds for each value and the requirement of data points not decreasing. Furthermore, the single improved point 526 remains close to the value of the three data points 524. In some examples, this is consistent with example Pseudo Code 4, described above. As such, energy savings result by avoiding storing large quantities of data by, for example, replacing the three data points 524 with a single improved point 526. In particular, the required storage decreases from three data points to one data point, thereby reducing storage requirements and reducing bandwidth requirements when transmitting quantities of data. However, in the process of pooling the three data points 524, the information included in the three data points 524 is preserved and represented by the single improved data point 526. The example shown in FIG. 5, is one example where the expected results are determined to be non-decreasing. However, examples disclosed herein are not limited to non-decreasing examples. In some instances, the constraint may be that the retrieved data, xᵢ^{o}, 506 is expected to be non-increasing. In other words, all consecutive data points shall be less than previous data points.

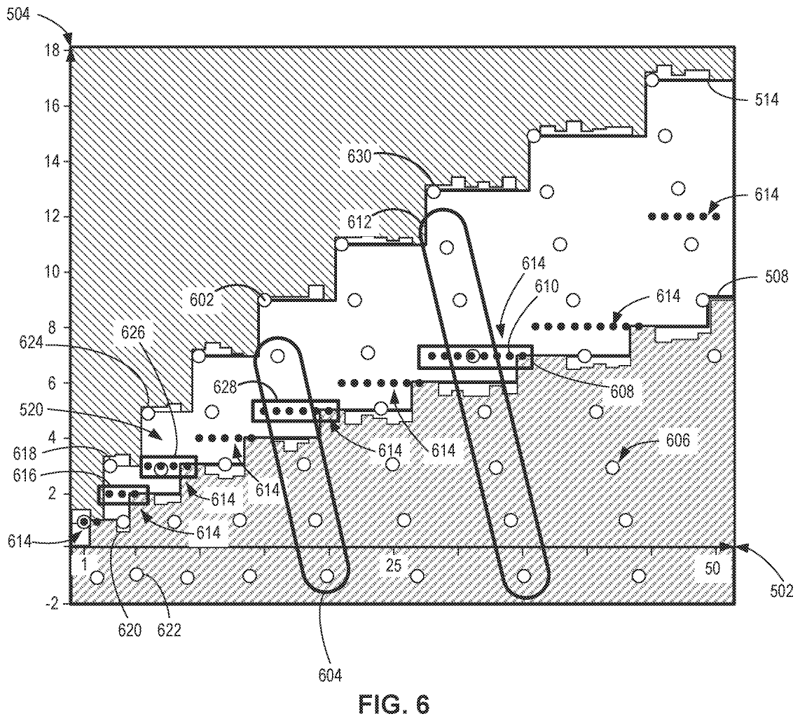

FIG. 6 is a graph of another example fifty data points prior to the pool circuitry 112 of FIG. 2 optimizing isotonic regression and a resultant solution after the pool circuitry 112 optimizes. In this example, retrieved data, xᵢ^{o}, of fifty data points, n, 606 is intentionally difficult for the example Pseudo Codes 1-5 to optimize. For instance, data point fifteen, x^{o}₁₅, 602 is followed by five decreasing data points, x^{o}₁₆. x^{o}₂₀, 604 that the Pseudo Code 4 will optimize into a non-decreasing resultant 628. As shown in FIGS. 5 and 6, an x-axis 502 is defined by an interval, i, and a y-axis 504 on the graph is defined by measurements (e.g., values, quantities, rates, etc.) recorded at each interval, i, 502. The illustrated example of FIG. 6 includes a quantity, n, of fifty retrieved and/or acquired data points, xᵢ^{o}, 606, arranged in accordance with the intervals, i, 502, and intentionally difficult for the example Pseudo Codes 1-5 to interpret. In FIG. 6, an optimized isotonic regression solution is also shown in the graph by the solid black dots, which represent the minimizers, xᵢ*, 610. In this example, the optimized isotonic regression solution includes nine subsets, s, 614, as defined above in Pseudo Code 4. Each subset, s, 614 includes a quantity of pooled data points, Nₖ. For example, subset 608 includes eight minimizers, xᵢ*, 610 with the value seven, and the variable Nₖ equals eight. The eight minimizers, xᵢ*, 610 are a result of pooling seven decreasing (e.g., violators) retrieved data points, xᵢ^{o}, 612 with a previous non-violator 630. In some examples, the pool circuitry 112 pools and determines the eight minimizers, xᵢ*, 610 by using Pseudo Code 4 and 5. In some examples, the quantity of minimizers, xᵢ*, 610 within the subsets is equal to the quantity of decreasing data points plus the previous data point until the retrieved data, xᵢ^{o}, 606 reaches an increasing (e.g., non-violator) data point. For example, a second subset of minimizers 616 includes three minimizers 610 because data point three, x^{o}₃, 618 is followed by two decreasing data points, x^{o}₄ and x^{o}₅, 620, 622. Further, data point six, x^{o}₆, 624 is increasing with a value of five as compared to the subset of minimizers 616 with a value of 2, and thus, a new subset 626 is started.

Further, FIG. 6 illustrates the lower boundary 508, lᵢ, and the upper boundary 514, uᵢ, which define the valid area 520, as illustrated in the graph by the white region, wherein all retrieved data points, xᵢ^{o}, 606 are predicted to fall within. As illustrated, all minimizers, xᵢ*, 610 fall within the valid area 520. The fifty data points, n, 606 have been corrected (e.g., revised, augmented, replaced, etc.) with minimizers that no longer violate the constraints and/or trend rules. In this example, the optimized isotonic regression solution includes minimizers, xᵢ*, 610 for each of the retrieved data points, xᵢ^{o}, 606. For example, if there are fifty retrieved data points, xᵢ^{o}, 606, the optimized isotonic regression solution includes fifty minimizers, xᵢ*, 610. In other examples, one minimizer, xᵢ*, 610 is generated for each subset, s, 614. For example, if there are nine subsets, s, 614, then nine minimizers, xᵢ*, 610, one for each subset, s, 614 are generated. With fewer minimizers, xᵢ*, 610 less storage is required for the resultant solution, thus, energy consumption is reduced.

FIG. 7 is a block diagram of an example processor platform 700 structured to execute and/or instantiate the machine readable instructions and/or the operations of FIGS. 3-4 to implement the pool circuitry 112 of FIG. 2. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs, microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the example data retriever circuitry 202, the example data arrangement circuitry 204, the example boundary analysis circuitry 206, the example consistency analysis circuitry 208, the example interim analysis circuitry 210, the example minimizer circuitry 212 and the example pool circuitry 112.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 732, which may be implemented by the machine readable instructions of FIGS. 2-6, may be stored in the mass storage device 728, in the volatile memory 714, in the non-volatile memory 716, and/or on a removable non-transitory computer readable storage medium such as a CD or DVD.

FIG. 8 is a block diagram of an example implementation of the processor circuitry 712 of FIG. 7. In this example, the processor circuitry 712 of FIG. 7 is implemented by a microprocessor 800. For example, the microprocessor 800 may be a general purpose microprocessor (e.g., general purpose microprocessor circuitry). The microprocessor 800 executes some or all of the machine readable instructions of the flowcharts of FIGS. 3-4 to effectively instantiate the pool circuitry 112 of FIG. 2 as logic circuits to perform the operations corresponding to those machine readable instructions. In some such examples, the pool circuitry 112 of FIG. 2 is instantiated by the hardware circuits of the microprocessor 800 in combination with the instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 3-4.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 9 is a block diagram of another example implementation of the processor circuitry 712 of FIG. 7. In this example, the processor circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 3-4 but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowcharts of FIGS. 2-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowcharts of FIGS. 3-4. As such, the FPGA circuitry 900 may be structured to effectively instantiate some or all of the machine readable instructions of the flowcharts of FIGS. 3-4 as dedicated logic circuits to perform the operations corresponding to those software instructions in a dedicated manner analogous to an ASIC. Therefore, the FPGA circuitry 900 may perform the operations corresponding to the some or all of the machine readable instructions of FIGS. 3-4 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may be implemented by external hardware circuitry. For example, the external hardware 906 may be implemented by the microprocessor 800 of FIG. 8. The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations that may correspond to at least some of the machine readable instructions of FIGS. 3-4 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modem FPGA circuitry may include an on-board CPU, such as one or more of the example CPU 920 of FIG. 9. Therefore, the processor circuitry 712 of FIG. 7 may additionally be implemented by combining the example microprocessor 800 of FIG. 8 and the example FPGA circuitry 900 of FIG. 9. In some such hybrid examples, a first portion of the machine readable instructions represented by the flowcharts of FIGS. 3-4 may be executed by one or more of the cores 802 of FIG. 8, a second portion of the machine readable instructions represented by the flowcharts of FIGS. 3-4 may be executed by the FPGA circuitry 900 of FIG. 9, and/or a third portion of the machine readable instructions represented by the flowcharts of FIGS. 3-4 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

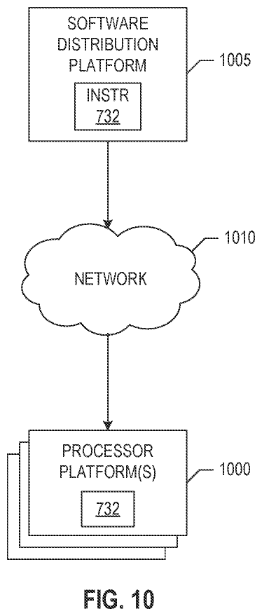

A block diagram illustrating an example software distribution platform 1005 to distribute software such as the example machine readable instructions 732 of FIG. 7 to hardware devices owned and/or operated by third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 3-4, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 3-4, may be downloaded to the example processor platform 700, which is to execute the machine readable instructions 732 to implement the pool circuitry 112. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices.

From the foregoing, it will be appreciated that example systems, methods, apparatus, and articles of manufacture have been disclosed that reduce the unnecessary consumption of computing resources in circumstances where isotonic regression is utilized. Because examples disclosed herein do not require intensive computations and reduce the amount of storage required, computing resources are conserved that would have otherwise been wasted on constraint violators. Disclosed systems, methods, apparatus, and articles of manufacture improve, enhance, increase, and/or boost the efficiency of using a computing device by using soft computations to pool adjacent violators under interval constraints. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to improve isotonic regression are disclosed herein. Further examples and combinations thereof include the following:

Example 1 includes an apparatus to improve isotonic regression, the apparatus comprising interface circuitry, machine readable instructions, and programmable circuitry to at least one of instantiate or execute the machine readable instructions to analyze a set of data points to generate a subset of data points that violate a trend rule, average the subset of data points to establish a pooled data point value, and adjust the pooled data point value to satisfy an upper boundary and a lower boundary corresponding to respective subset data point interval bound information to generate a minimizer.

Example 2 includes the apparatus as defined in example 1, wherein the subset of data points includes adjacent violators of the trend rule, and the subset of data points is complete if a non-violator data point of the trend rule is met.

Example 3 includes the apparatus as defined in example 1, wherein the trend rule is the set of data point values that are non-decreasing.

Example 4 includes the apparatus as defined in example 1, wherein the trend rule is the set of data point values that are non-increasing.

Example 5 includes the apparatus as defined in example 1, wherein the programmable circuitry is to generate the minimizer for the subset of data points.

Example 6 includes the apparatus as defined in example 1, wherein the programmable circuitry is to generate the minimizer for each data point within the subset of data points.

Example 7 includes the apparatus as defined in example 1, wherein the set of data points includes interval bound information including upper bound values and lower bound values.

Example 8 includes the apparatus as defined in example 7, wherein the lower boundary and the upper boundary are based on the interval bound information, the programmable circuitry to determine the set of data points values satisfy the lower boundary and the upper boundary.

Example 9 includes the apparatus as defined in example 7, wherein programmable circuitry is to evaluate whether ones of the lower bound values are less than respective ones of the upper bound values, and one of (a) maintain model training when the ones of the lower bound values are less than respective ones of the upper bound values or (b) prevent model training if any lower bound value is greater than the respective upper bound value.

Example 10 includes the apparatus as defined in example 1, wherein the set of data points is revised with minimizers corresponding to respective ones of the pooled data points within the subset of data points.

Example 11 includes an apparatus to improve isotonic regression, the apparatus comprising interface circuitry to retrieve data, computer readable instructions, and programmable circuitry to instantiate interim analysis circuitry to analyze a set of data points to generate a subset of data points that violate a trend rule, and average the subset of data points to establish a pooled data point value, and minimizer circuitry to adjust the pooled data point value to satisfy an upper boundary and a lower boundary corresponding to respective subset data point interval bound information to generate a minimizer.

Example 12 includes the apparatus as defined in example 11, wherein the subset of data points includes adjacent violators of the trend rule, and the subset of data points is complete if a non-violator data point of the trend rule is met.

Example 13 includes the apparatus as defined in example 11, wherein the trend rule is the set of data point values that are non-decreasing.

Example 14 includes the apparatus as defined in example 11, wherein the trend rule is the set of data point values that are non-increasing.

Example 15 includes the apparatus as defined in example 11, wherein the minimizer circuitry generates the minimizer for the subset of data points.

Example 16 includes the apparatus as defined in example 11, wherein the minimizer circuitry generates the minimizer for each data point within the subset of data points.

Example 17 includes the apparatus as defined in example 11, wherein the set of data points includes interval bound information including upper bound values and lower bound values.

Example 18 includes the apparatus as defined in example 17, further including boundary analysis circuitry to analyze the lower boundary and the upper boundary based on the interval bound information wherein the set of data points values must satisfy the lower boundary and the upper boundary.

Example 19 includes the apparatus as defined in example 17, further includes consistency analysis circuitry to evaluate whether ones of the lower bound values are less than respective ones of the upper bound values, and one of (a) maintain model training when the ones of the lower bound values are less than respective ones of the upper bound values or (b) prevent model training if any lower bound value is greater than the respective upper bound value.

Example 20 includes a method to improve isotonic regression, the method comprising analyzing, by executing instructions with at least one processor, a set of data points to generate a subset of data points that violate a trend rule, averaging, by executing instructions with at least one processor, the subset of data points to establish a pooled data point value, and adjusting, by executing instructions with at least one processor, the pooled data point value to satisfy an upper boundary and a lower boundary corresponding to respective subset data point interval bound information to generate a minimizer.

Example 21 includes the method as defined in example 20, wherein the set of data points includes interval bound information including an upper bound value and a lower bound value.

Example 22 includes the method as defined in example 21, wherein the lower boundary and the upper boundary are based on the interval bound information wherein the set of data points values must satisfy the lower boundary and the upper boundary.

Example 23 includes the method as defined in example 21, further including to evaluating, by executing instructions with at least one processor, whether ones of the lower bound values are less than respective ones of the upper bound values, and one of (a) maintain model training when the ones of the lower bound values are less than respective ones of the upper bound values or (b) prevent model training if any lower bound value is greater than the respective upper bound value.

Example 24 includes the method as defined in example 20, wherein the subset of data points includes adjacent violators of the trend rule, and the subset of data points is complete if a non-violator data point of the trend rule is met.

Example 25 includes the method as defined in example 20, wherein the trend rule is the set of data point values that are non-decreasing.

Example 26 includes the method as defined in example 20, wherein the trend rule is the set of data point values that are non-increasing.

Example 27 includes the method as defined in example 20, wherein the minimizer is generated for the subset of data points.

Example 28 includes the method as defined in example 20, wherein the minimizer is generated for each data point within the subset of data points.

Example 29 includes the method as defined in example 20, wherein the set of data points is corrected with minimizers corresponding to respective ones of the pooled data points within the subset of data points.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus to improve isotonic regression, the apparatus comprising:
interface circuitry;
machine readable instructions; and
programmable circuitry to at least one of instantiate or execute the machine readable instructions to:
analyze a set of data points to generate a subset of data points that violate a trend rule;
average the subset of data points to establish a pooled data point value; and
adjust the pooled data point value to satisfy an upper boundary and a lower boundary corresponding to respective subset data point interval bound information to generate a minimizer.

2. The apparatus as defined in claim 1, wherein the subset of data points includes adjacent violators of the trend rule, and the subset of data points is complete if a non-violator data point of the trend rule is met.

3. The apparatus as defined in claim 1, wherein the trend rule is the set of data point values that are non-decreasing.

4. The apparatus as defined in claim 1, wherein the trend rule is the set of data point values that are non-increasing.

5. The apparatus as defined in claim 1, wherein the programmable circuitry is to generate the minimizer for the subset of data points.

6. The apparatus as defined in claim 1, wherein the programmable circuitry is to generate the minimizer for each data point within the subset of data points.

7. The apparatus as defined in claim 1, wherein the set of data points includes interval bound information including upper bound values and lower bound values.

8. The apparatus as defined in claim 7, wherein the lower boundary and the upper boundary are based on the interval bound information, the programmable circuitry to determine the set of data points values satisfy the lower boundary and the upper boundary.

9. The apparatus as defined in claim 7, wherein programmable circuitry is to:
evaluate whether ones of the lower bound values are less than respective ones of the upper bound values; and
one of (a) maintain model training when the ones of the lower bound values are less than respective ones of the upper bound values or (b) prevent model training if any lower bound value is greater than the respective upper bound value.

10. The apparatus as defined in claim 1, wherein the set of data points is revised with minimizers corresponding to respective ones of the pooled data points within the subset of data points.

11. An apparatus to improve isotonic regression, the apparatus comprising:
interface circuitry to retrieve data;
computer readable instructions; and
programmable circuitry to instantiate:
interim analysis circuitry to:
analyze a set of data points to generate a subset of data points that violate a trend rule; and
average the subset of data points to establish a pooled data point value; and
minimizer circuitry to adjust the pooled data point value to satisfy an upper boundary and a lower boundary corresponding to respective subset data point interval bound information to generate a minimizer.

12. The apparatus as defined in claim 11, wherein the subset of data points includes adjacent violators of the trend rule, and the subset of data points is complete if a non-violator data point of the trend rule is met.

13. The apparatus as defined in claim 11, wherein the trend rule is the set of data point values that are non-decreasing.

14. The apparatus as defined in claim 11, wherein the trend rule is the set of data point values that are non-increasing.

15. (canceled)

16. (canceled)

17. (canceled)

18. (canceled)

19. The apparatus as defined in claim 17, further includes consistency analysis circuitry to:
evaluate whether ones of the lower bound values are less than respective ones of the upper bound values; and
one of (a) maintain model training when the ones of the lower bound values are less than respective ones of the upper bound values or (b) prevent model training if any lower bound value is greater than the respective upper bound value.

20. A method to improve isotonic regression, the method comprising:
analyzing, by executing instructions with at least one processor, a set of data points to generate a subset of data points that violate a trend rule;
averaging, by executing instructions with at least one processor, the subset of data points to establish a pooled data point value; and
adjusting, by executing instructions with at least one processor, the pooled data point value to satisfy an upper boundary and a lower boundary corresponding to respective subset data point interval bound information to generate a minimizer.

21. The method as defined in claim 20, wherein the set of data points includes interval bound information including an upper bound value and a lower bound value.

22. The method as defined in claim 21, wherein the lower boundary and the upper boundary are based on the interval bound information wherein the set of data points values must satisfy the lower boundary and the upper boundary.

23. The method as defined in claim 21, further including to:
evaluating, by executing instructions with at least one processor, whether ones of the lower bound values are less than respective ones of the upper bound values; and
one of (a) maintain model training when the ones of the lower bound values are less than respective ones of the upper bound values or (b) prevent model training if any lower bound value is greater than the respective upper bound value.

24. The method as defined in claim 20, wherein the subset of data points includes adjacent violators of the trend rule, and the subset of data points is complete if a non-violator data point of the trend rule is met.

25. (canceled)

26. (canceled)

27. (canceled)

28. (canceled)

29. (canceled)
